(19) United States
(12) Patent Application Publication
(10) Pub. No.: US 2017/0249582 A1
(43) Pub. Date: Aug. 31, 2017

(54) INTERMODAL DELIVERY OPTIMIZATION

(71) Applicant: Eric Paul Mademann, Naperville, IL (US)

(72) Inventor: Eric Paul Mademann, Naperville, IL (US)

(21) Appl. No.: 15/445,165

(22) Filed: Feb. 28, 2017

Related U.S. Application Data
(60) Provisional application No. 62/301,499, filed on Feb. 29, 2016.

(51) Int. Cl. G06Q 10/08

(52) U.S. Cl. CPC G06Q 10/083; G06Q 10/0831

(57) ABSTRACT

Intermodal delivery optimization includes receiving a destination door location and determining destination interchange points delivering to the destination door location. A door delivery cost is calculated from each destination interchange point to the destination door location, and inland transport paths from a port to each destination interchange point are identified. An inland transport cost is aggregated for the inland transport paths, and a total delivery cost including the inland transport cost and the door delivery cost is determined. The optimum intermodal delivery route is selected from the plurality of intermodal delivery routes and provided for display.

### CROSS-REFERENCE TO RELATED APPLICATION

This application claims the benefit of the filing date under 35 U.S.C. §119(e) of U.S. Provisional Application No. 62/301,499, filed Feb. 29, 2016, the entire content of which is hereby incorporated by reference.

### BACKGROUND

### Field/Field of the Disclosure/Technical Field

The disclosure is generally directed to computer implemented commercial delivery services, and more particularly, to intermodal delivery optimization.

### Description of Related Art

A globalized economy requires the international shipment of products around the world. Several modes of transportation are often necessary to move products in the stream of commerce. For example, a shipping carrier company importing products to the United States routes products first to one of its marine ports. Door trucking services are offered by a carrier to a shipper/customer in which the carrier agrees to provide transportation (for imports) from the location the cargo loads (the shipper's door) or to the final destination at which the cargo is to be delivered. The product is carried from the marine port via rail and/or truck to its inland door destination. Commercial carriers and brokers provide door delivery services, delivering the product to a specified address, such as a warehouse, in order to complete delivery. Delivery costs are incurred for each leg of the product's travel.

An accurate determination of shipping cost includes determination of an end-to-end route and total cost that may include multiple modes of transit. Accurate cost estimation thus depends on the determination of shipping rates for each segment of a trip. The sheer number of possible delivery routes is large. Such an estimate is additionally difficult due to the frequent range of shipping rates. Frequently, carrier companies are asked to provide estimates calculating the cost of a shipment as a part of its ongoing business.

Conventionally, sales representatives of carriers rely on multiple sources of information in order to determine door pricing in response to shipping cost inquiries. The exact delivery cost often not available immediately if the total cost for any single leg of a route is not predetermined and stored. Partial pricing information may be available for segments of a route, but the carrier sales representative may need to communicate with multiple intercompany departments to obtain specific door pricing. In order to complete the pricing estimate, the sales representative must manually add door pricing to estimated pricing for the rest of the shipping route.

Route cost determination is complicated by the need for both publically available and confidential information. Rail, truck, port, accessorial, variable regional and empty repositioning costs are often confidential and specific to the shipper. Several third parties are further involved in the determination of costs. For example, toll costs may be determined by government entities.

Furthermore, there is a need in the art to provide multiple possible inland shipping routes. Evaluation and comparison of the potential shipping routes are further desired. While experienced sales representatives may be able to quickly identify multiple possible routes or rule out interchange points a non-viable options, it is difficult or impossible for a sales representative to quickly identify and generate a cost estimate that reflects all variance in shipping costs on the fly. Thus, a sales representative may not be able to conduct any optimization of the estimated shipment to the specific destination with any consistency or accuracy.

Conventionally, it may not be possible to immediately generate an end-to-end route cost. In some conventional computer-implemented pricing applications, costs associated with each leg of the route may not be available and/or pricing may not be available at the granularity necessary to immediately determine the door delivery cost.

A need exists to provide cost-efficient delivery services. Conventional delivery cost estimation is frequently delayed or unavailable for end-to-end routes if pre-determined delivery costs are not readily available. Conventional delivery estimation computer programs cannot generate an end-to-end cost if exact pricing is unavailable for any leg of a desired route.

Commercial shipping costs are dependent on pricing that is maintained confidentially by each carrier. Port selection, vessel service selection, and direction vary for each commercial carrier. Dynamically fluctuating pricing further complicates the process of obtaining current and accurate cost estimates. Pre-determined (tariff) door delivery costs to a door location become outdated if any component of the pricing changes.

### BRIEF SUMMARY

The disclosure below provides benefits and improvements over the conventional art in intermodal delivery optimization. Apparatuses, systems, and methods are provided.

Additional objects, advantages and novel features of the examples are set forth in part in the description below, and in part are apparent to those skilled in the art upon examination of the following description and the accompanying drawings or may be learned by production or operation of the examples.

An intermodal delivery optimization system includes at least one processor and at least one memory. The memory includes computer program code for one or more programs; the at least one memory and the computer program code configured to, with the at least one processor, cause the system to receive a destination door location and determine a plurality of destination interchange points delivering to the destination door location. The system is further caused to calculate a door delivery cost from each destination interchange point to the destination door location; identify a plurality of inland transport paths from one or more possible ports to each of the plurality of destination interchange points; and aggregate an inland transport cost for each of the plurality of inland transport paths. The system also determines a total delivery cost for a plurality of intermodal delivery routes. Each intermodal delivery route is a path from a possible port to the destination door location, and the total delivery cost includes the inland transport cost and the door delivery cost. The system additionally selects an optimum intermodal delivery route from the plurality of intermodal delivery routes with the lowest total delivery cost; and provides the optimum intermodal delivery route for display.

A method is provided for intermodal delivery optimization. The method includes receiving a destination door location and determining a plurality of destination interchange points delivering to the destination door location. The method also includes calculating a door delivery cost from each destination interchange point to the destination door location; identifying a plurality of inland transport paths from one or more possible ports to each of the plurality of destination interchange points; and aggregating an inland transport cost for each of the plurality of inland transport paths. The method also determines a total delivery cost for multiple intermodal delivery routes. Each intermodal delivery route is a path from a possible port to the destination door location. The total delivery cost includes the inland transport cost and the door delivery cost. The method further selects an optimum intermodal delivery route from the plurality of intermodal delivery routes with the lowest total delivery cost; and provides the optimum intermodal delivery route for display.

A non-transitory computer readable medium is provided including instructions that may be executed by a processor. When executed, the instructions are operable to receive a destination door location; and determine a plurality of destination interchange points delivering to the destination door location. The non-transitory computer readable medium further includes instructions executing the calculation of a door delivery cost from each destination interchange point to the destination door location; identification of multiple possible inland transport paths from one or more possible ports to each of the plurality of destination interchange points; and aggregation of an inland transport cost for each of the possible inland transport paths. The non-transitory computer readable medium also includes instructions that execute the determination of a total delivery cost for a plurality of intermodal delivery routes. Each intermodal delivery route is a path from a possible port to the destination door location, and the total delivery cost includes the inland transport cost and the door delivery cost. The non-transitory computer readable medium also includes instructions executing the selection of an optimum intermodal delivery route from the plurality of intermodal delivery routes with the lowest total delivery cost; and the provision of the optimum intermodal delivery route for display.

### BRIEF DESCRIPTION OF THE DRAWINGS

Exemplary embodiments of the disclosure are described with reference to the following drawings.

FIGS. 1A-1D illustrate potential routes and interchange points for an embodiment of intermodal route optimization.

FIG. 2 illustrates an example computing system for intermodal delivery optimization according to the teachings of the present disclosure.

FIG. 3 illustrates an example server for the intermodal delivery optimization system of FIG. 1.

FIG. 4 illustrates an example client device for the intermodal delivery optimization system of FIG. 1.

FIG. 5 is a flow diagram in accordance with one embodiment of intermodal delivery optimization.

FIG. 6 is a flow diagram in accordance with the present disclosure for intermodal delivery optimization.

FIG. 7 is a flow diagram in accordance with the present disclosure for intermodal delivery optimization.

FIG. 8 is a flow diagram in accordance with the present disclosure for intermodal delivery optimization.

FIG. 9 is a flow diagram in accordance with the present disclosure for intermodal delivery optimization.

FIG. 10 is a flow diagram in accordance with the present disclosure for intermodal delivery optimization.

FIGS. 11A-11E are example graphical user interfaces for intermodal delivery optimization.

### DETAILED DESCRIPTION

Intermodal delivery optimization provides an industry-specific, customized program to compare all fixed and variable costs for a cargo shipment. Delivery route optimization is beneficial to carriers providing door-trucking services in the intermodal transportation industry. Intermodal shipping refers to means of shipping cargo in which the supply chain incorporates multiple modes of transportation, e.g., truck, rail, vessel, and the like.

The provided intermodal delivery optimization system, apparatus, and methods maximize cost-efficiencies to determine the optimal route between two locations. A goal is to provide automation of a previously hand operated process. A further goal is to provide more complete results and increase accuracy from the previously hand operated process. A further goal is to reduce the time required to generate delivery routes. Another goal is to make it possible to accurately price routes terminating at door locations that do not have direct, specified costs pre-determined and stored in a primary operating/pricing system. A goal is to maintain accurate intermodal delivery optimization despite missing costs and constant fluctuation and changing in various pricing components.

Intermodal Delivery Optimization provides route optimization for carriers providing door-trucking service. Route optimization is determining the most efficient inland delivery path from shipping port to door location. Determination of possible routes, comparison of routing options and providing the optimized route are provided.

The end-to-end route may include each segment of travel from the origin point to the destination point. End-to-end route may additionally refer to the inland door delivery from the port to destination location or origin point to port discharge point. Each segment of travel is the path (e.g., rail or road) connecting one interchange point with another. The path between the destination interchange point and the door location is also a segment of the end-to-end route.

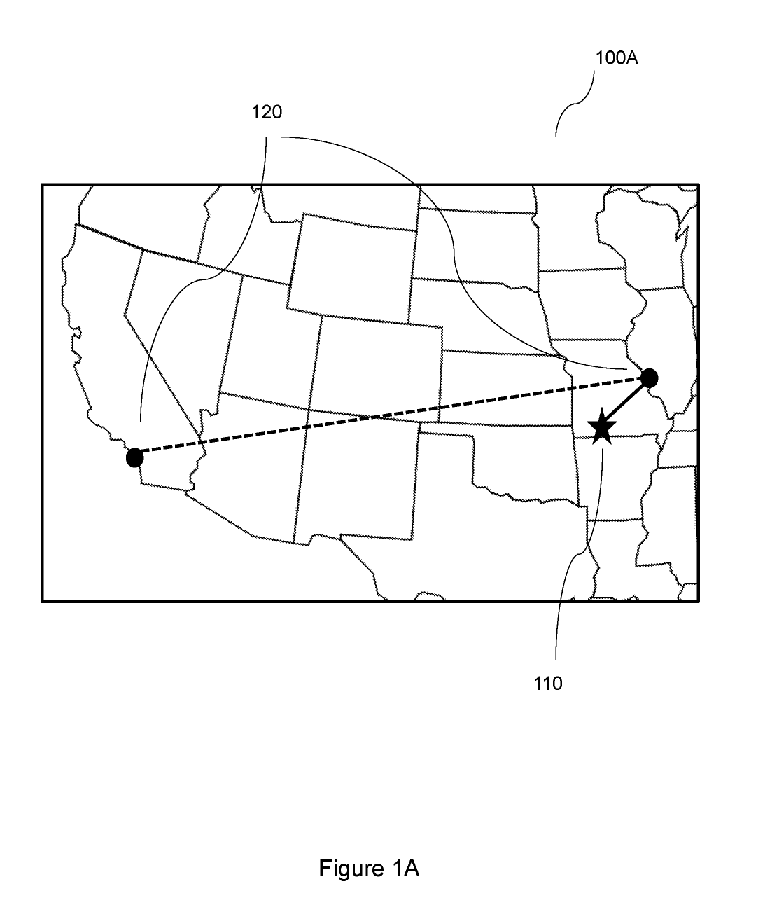

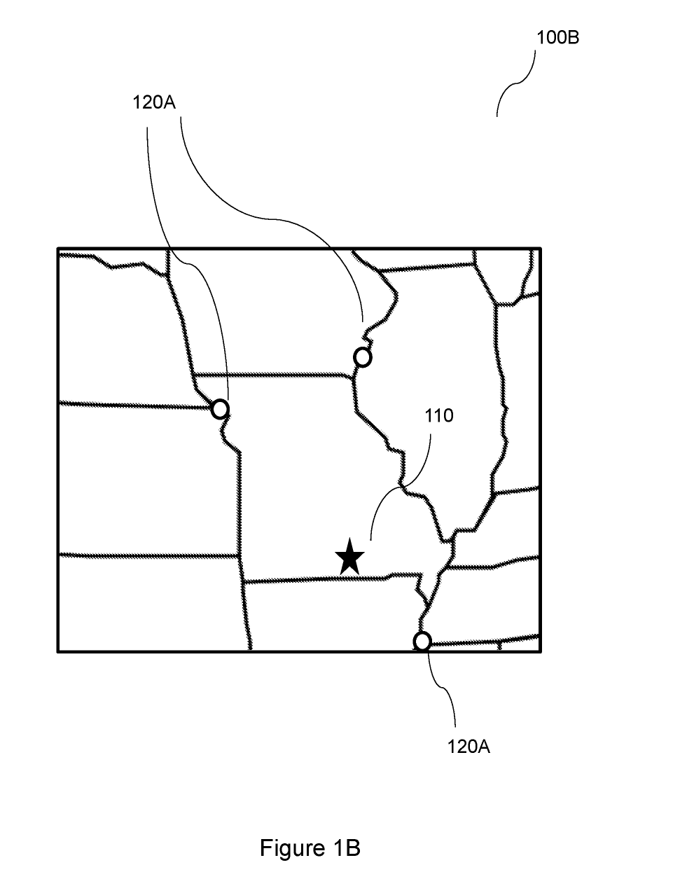

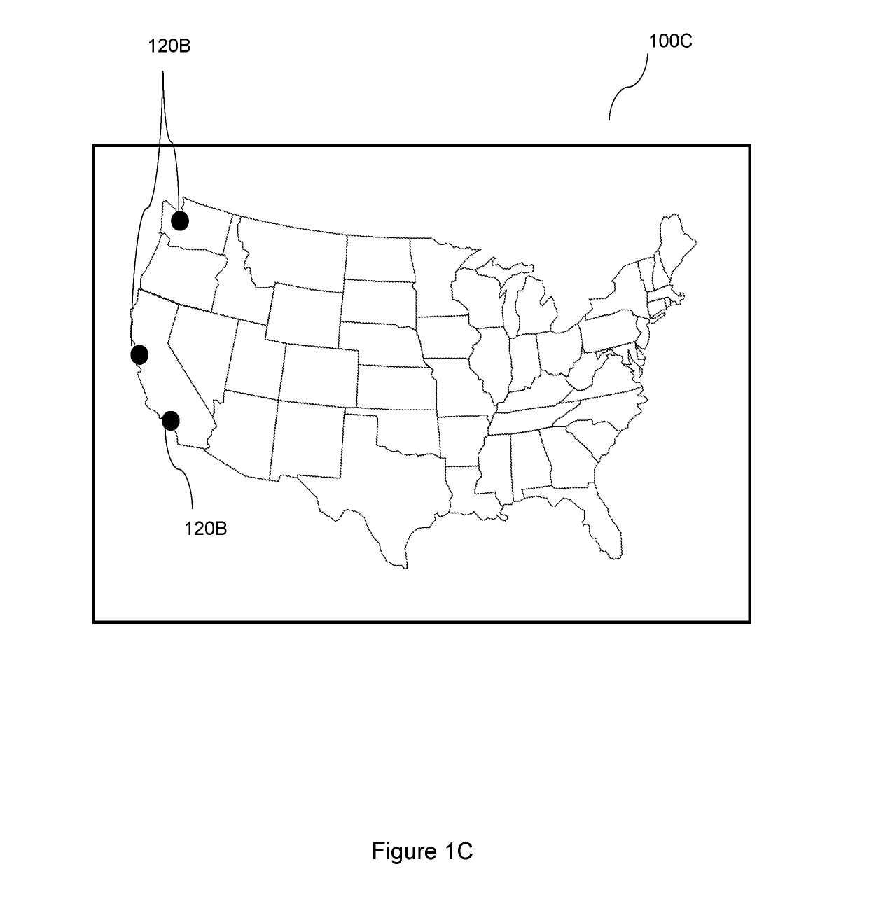

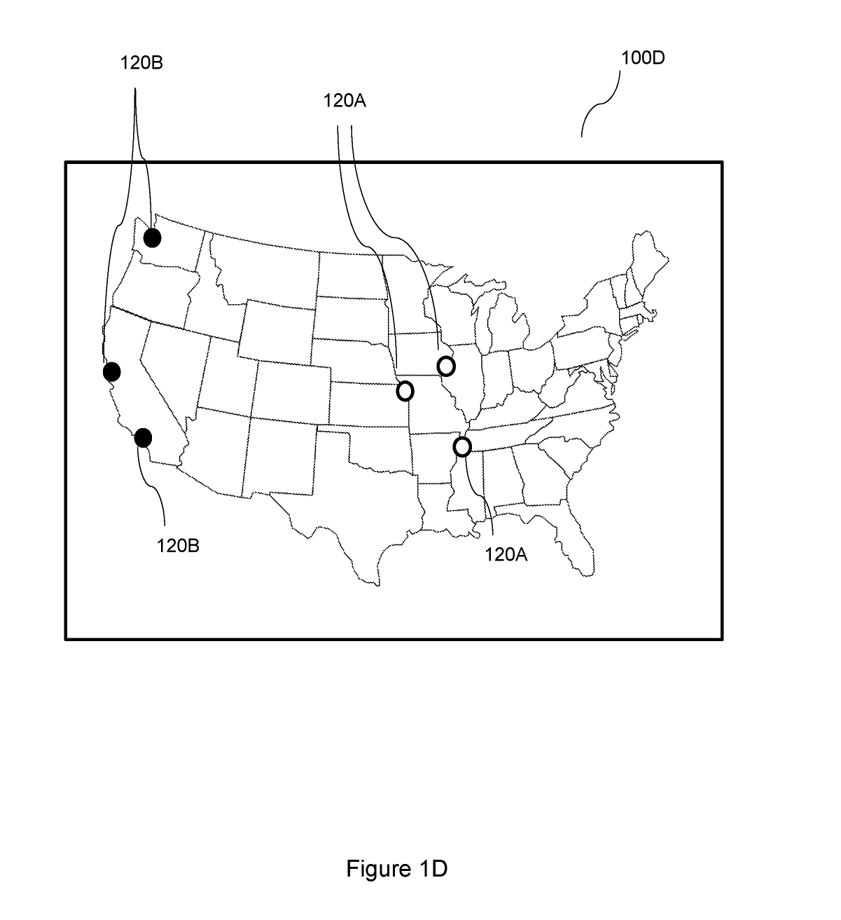

An interchange point is the location at which the mode of transportation changes (e.g., truck to rail, vessel to truck). An interchange point may refer to a marine terminal or port, a hub, container yard or other transit location. Interchange points, along with port selection, vessel service selection, and available shipping direction may be specific to both shipper and carrier. For examples locations 120, 120A, and 120B as illustrated in FIGS. 1A-1D indicate interchange points. In those Figures, points 120B are port interchange points and points 120A represent trucking interchange points.

The cost of each segment may be dependent on multiple costs and factors. The cost of some segments may consist only of a flat rate (such as rail transit costs between interchange points). A segments cost may include both flat and variable rates (such as a rail transit cost and additional fees dependent on interchange point, geographic region, or other fees. A segment cost may be dependent on several sources of cost including: cost-per-mile rates, length of the segment, region, direction of travel, and other fees.

### System Architecture

Client/Server Model

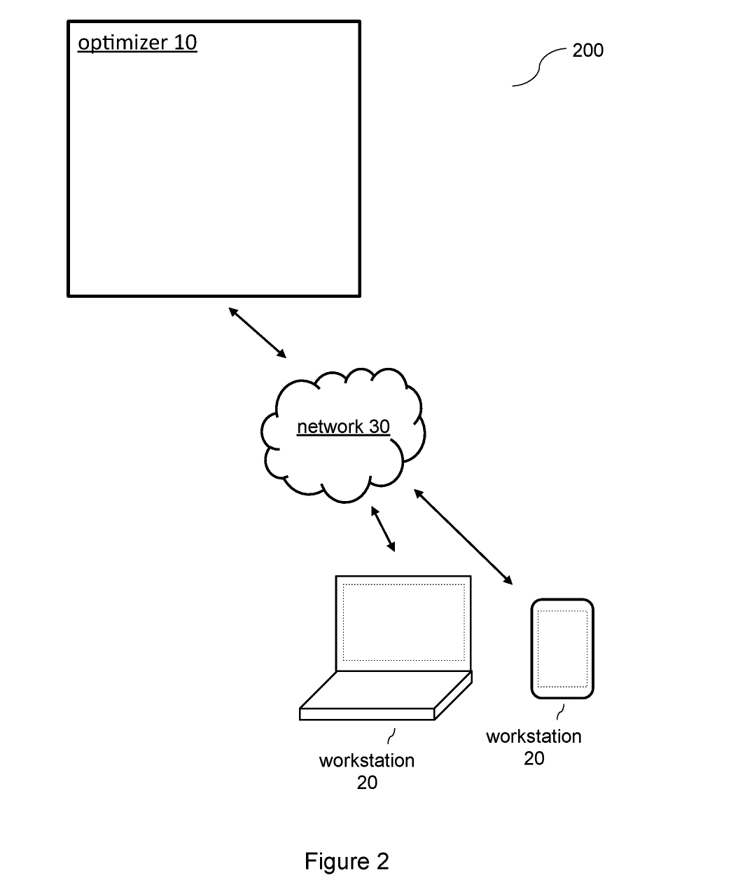

A computing system 200 is configured and operated using various hardware and/or software components. FIG. 2 illustrates one example computing system for intermodal delivery optimization. The illustrated intermodal delivery optimization system includes the optimizer 10, workstation 20, and network 30. Alternative and/or additional embodiments of the computing system 200 may include one or more of each of the illustrated components or a combination thereof. For example, system 200 may include multiple client devices 20.

In some embodiments, the functions of multiple components may be successfully performed by one of the illustrated components. The computing system 200 may include directly coupled components that communicate without an intervening network.

Any one or more individual components, such as optimizer 10 may be housed in a single physical device or may be configured to exploit distributed processes or cloud computing. The computing system 200 may be fully described from the perspective of one or more individual components. Workstation 20 and optimizer 10 are communicatively coupled via one or more networks 30. Each of these components is discussed in turn, below.

Server/Optimizer 10

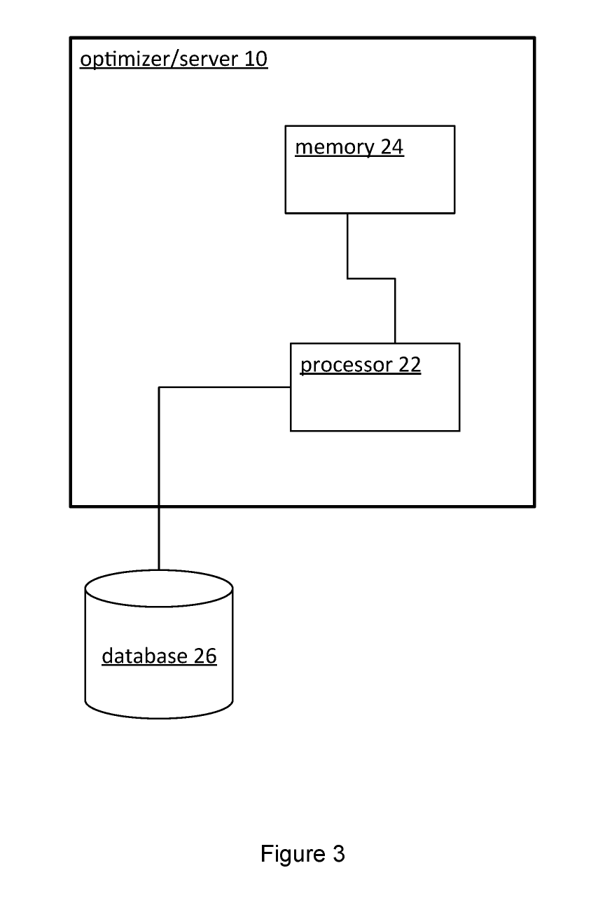

The optimizer 10 may be a server and may include one or more processor 22, memory 24, database 26, and workstation 28 as illustrated in FIG. 3. Optimizer 10 may be a server. The term “server” collectively includes the components of optimizer 10 for creating, maintaining, and updating database 26. The term “database” as used herein refers to a storage medium and is not necessarily limited to any specific relational organization requirements, except where explicitly specified. One or more sets of software instructions may be stored in memory 24 or may be stored in database 26 and executed by processor 22. Processor 22 may be in communication with client devices 20 via the network 30.

Optimizer 10 may acquire, create, maintain and/or obtain databases including carrier determined pricing and third party pricing associated with intermodal delivery optimization. Optimizer 10 may also store master copies and updates of computer programs that may be downloaded on a client device as an application, standalone program, module, script, code, subroutine, or combinations thereof. Optimizer 10 may also be a host for a website or web service providing intermodal delivery optimization as described herein.

Optimizer 10 may obtain data stored in its associated databases via input through a workstation 20 associated with the carrier. Optimizer 10 may acquire delivery, geographic region, or other data. Additional navigation, mapping, fee, and rate data may be acquired by optimizer 10 from other sources via network 30 or via a workstation 20 coupled to optimizer 10. Third party data may be sourced from remote servers including similar components to those illustrated in FIG. 3. One or more sets of software instructions that are executed by the optimizer 10 may include navigation algorithms hosted by one or more remote servers communicatively coupled to optimizer 10 via network 30. Optimizer 10 may be used for determining the optimal intermodal delivery route based on received destination door location information from workstation 20 via network 30. Data received by the optimizer from remote servers may be stored in one or more databases 26 of the optimizer 10.

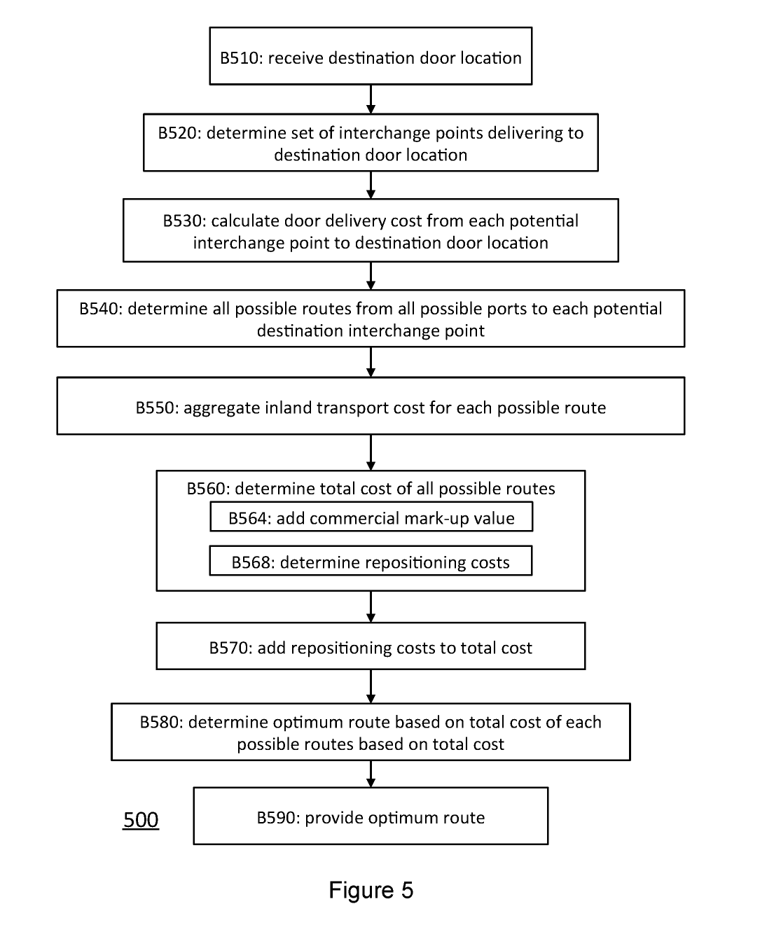

Processor 22 executes instructions stored in memory 24 and may access data stored in one or more databases 26. Processor 22 may be a hardware processor configured to perform predefined sets of basic operations upon receiving a corresponding basic instruction selected from a predefined native instruction set of codes. In some embodiments, each individual block as described below with respect to FIGS. 5-10 may be one or more software module and/or one or more set of machine codes selected from the native instruction set of codes. Instructions, such as the predefined native instruction set of codes may be stored in memory 24.

As stored in database 26, cost, path, region, geographic and other data may be available in a variety of data formats. Beneficially, the optimizer 10 stores data in database 26 that may include data tables. These data tables that may be independently maintained or updated from third party sources in order to maintain accuracy of shipping estimates despite changes in costs. Delivery data may originate from multiple sources, both within the carrier and from third parties. Some delivery data may be sourced from a third party vendor, and further customized internally by the carrier. Rate and cost changes may also originate from multiple sources including government transportation entities, the carrier's service offerings, and the contractual rates of upstream providers. Optimizer 10 may perform a conversion process on data tables such that data is uniformly accessible by a region identifier such as 3-digit zip code, 5-digit zip code, direction of travel, and/or mode of travel. The data conversion process performed by optimizer 10 may include generation of data table entries populating values for identifiers where no specific value is available. For example, the optimizer 10 may convert received data tables into a data table having region identifiers consisting of a 5-digit zip code. Advantageously, optimizer 10 is capable of automatically harmonizing multiple sources of data for use with intermodal delivery optimization as provided herein.

Trucking cost-per-mile is dependent on geographic region. These rates fluctuate over time. Cost may be influenced by supply and demand, contractual rates, geographic terrain, geographic labor and fuel cost differences, and other factors. Trucking cost-per-mile may be stored in one or more tables in one or more databases 26. The data may be indexed by geographic location such as a zip code, 3-digit zip code and the like. Trucking cost-per-mile data may be entered via workstation 28. Trucking cost-per-mile may be additionally or alternatively provided from remote servers in communication with optimizer 10 via network 30. For example, a trucking company may update cost-per-mile tables on a quarterly basis.

Database 26 may further include variance cost data. One or more tables may include geographic or directionally based variances. Database 25 may further include fees and cost based the empty location or termination location.

Workstation 20

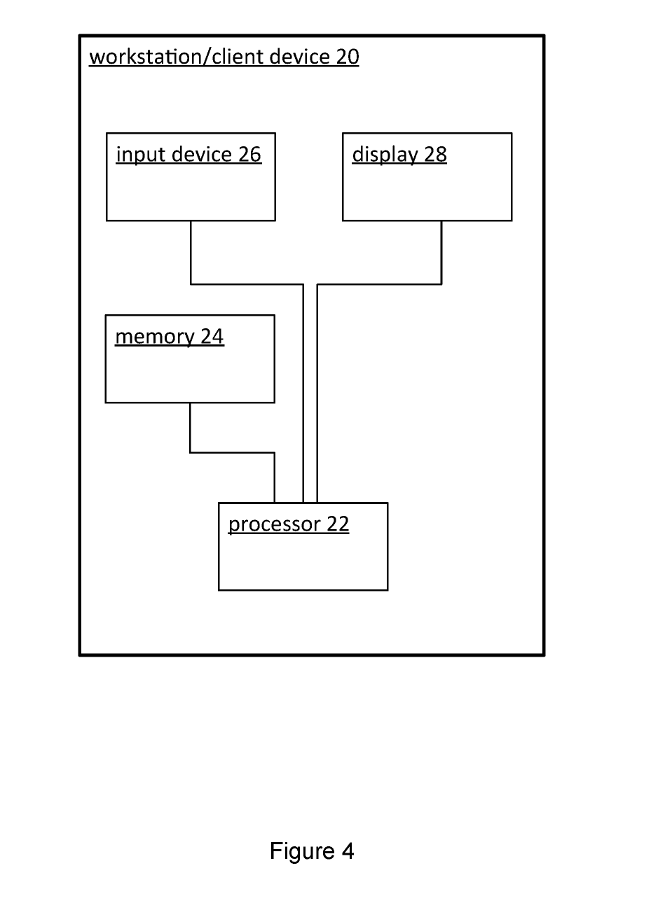

Workstation 20 provides user access to the optimizer 10. FIG. 4 illustrates an exemplary workstation 20. Any client device or computing device may be substituted for workstation 20. Workstation 20 may be a smart phone, mobile phone, a personal digital assistant, a tablet computer, a notebook computer, and/or any other known or later developed device or personal computer. The computing device may be a host for a website or web service for intermodal delivery optimization. Workstation 20 includes processor 22, memory 24, input device 26 and display 28.

Processor 22 executes instructions stored in memory 24 and may access data stored in one or more databases 26 of workstation 20. Processor 22 may be a hardware processor configured to perform predefined sets of basic operations upon receiving a corresponding basic instruction selected from a predefined native instruction set of codes. In some embodiments, each individual block as described below with respect to FIGS. 5-10 may be one or more software module and/or one or more set of machine codes selected from the native instruction set of codes. Instructions, such as the predefined native instruction set of codes may be stored in memory 24.

Memory 24 may include one or more client device applications including one or more computer programs that may be downloaded on workstation 20 as an application, standalone program, module, script, code, subroutine, or combinations thereof. The application may be downloaded to the workstation 20 from optimizer 10. Updates to the application may further be stored on optimizer 10 for access by the workstation 20. In some embodiments, a client device application of workstation 20 may include one or more system operation processes, such as those of FIGS. 5-10. The client device application may access data stored on databases 26 of optimizer 10. In some client device applications, data stored on databases 26 of optimizer 10 may be locally stored in memory 24 of workstation 20. Thus, one or more delivery route optimization processes may be performed by workstation 20 as a system, operating independently from optimizer 10.

The application may include instructions causing workstation 20 to execute instructions stored elsewhere on the workstation 20 or stored remotely and accessed via network 30. Alternatively, or additionally, client device 20 may include a Web browser through which a user may use services hosted by optimizer 10.

Memory 24 need not store complete copies of the databases 26 stored at the optimizer 10. Instead, the client device 20 may selectively query the one or more databases 26 of optimizer 10 to obtain cost and rate data.

The user of workstation 20 may provide input and further interact with the workstation 20 via display 28. The display 28 may be a touch graphical user interface display capable of displaying output and receiving user input via user contact and/or interaction with the surface of display 28. Alternative and additional input and output devices such as microphones, speakers, keyboards, stylus, mouse, or joysticks may serve as input and output devices accessed and used by processor 22. Input and/or output devices may be physically integrated with workstation 20 or connectively coupled to workstation 20.

Various graphical user interfaces may be rendered on display 28 as provided by instructions included in workstation memory 24 and executed by the processor 22. Alternatively, or additionally, graphical components may be received and rendered by workstation 20 pursuant to instructions and data originating from optimizer 10.

User entered data input is entered via input device 26 of workstation 20. Input data for a specific delivery may be provided by a shipper to the carrier and inputted by a carrier agent via input device 26 at workstation 20. In some embodiments, shippers may have access to the intermodal delivery optimization system directly, such that the shipper may directly execute shipping estimate inquiries.

Beneficially, in embodiments in which the shipper may access the system, confidential cost components are stored at optimizer 10. The shipper may have direct access to generate optimized shipping estimates without the need for the carrier to provide the shipper with access to confidential cost data. That is, the shipper may have access to a workstation 20, which sends and receives input and output to optimizer 10. In these embodiments, optimizer 10 conducts one or more processes and provides the results to workstation 20 via network 30. Accordingly, sensitive information is confidentially stored while also providing the shipper with increased accessibility to shipping cost estimates from the carrier.

Network 30

Network 30 communicatively couples optimizer 10 and workstation 20. The network may be wired or wireless or a combination thereof. Network 30 may include multiple types of network such as cellular telephone networks, personal area networks, local area networks, Bluetooth, low energy Bluetooth, Wi-Max, any networks meeting IEEE 802 standards, or a combination thereof. The network 30 may include the Internet or other public networks. Network 30 may include an intranet or other private network. Individual components of the computing system 200 may be communicatively coupled via network 30.

These system architecture components are intended to provide a general understanding of the structure of various embodiments of computing system 200. FIGS. 1-3 and accompanying description are not intended to serve as a complete description of all possible elements and features of apparatus, systems, and processes disclosed. Contemplated embodiments include structural and logical substitutions without departing from the scope of the disclosure.

### System Operation

Intermodal delivery optimization includes determination of possible routes between port and door location for imports and exports. Several possible routes may exist for each origin and destination point. Possible routes may vary in distance, cost, delivery time, mode of travel and the like. For an import, the intermodal delivery route may extend from the shipper's origin point to the destination door location, including marine shipping rates, or may be defined as the marine terminal to destination location, without including marine shipping rates. For example, one exemplary intermodal delivery route extends from a marine terminal to the destination location. The route is illustrated by the dashed and solid lines connecting interchange points 120 with destination location 110 in FIG. 1A. For an export, the intermodal delivery route may extend from an origin location to a destination location and may include marine shipping rate. An export intermodal delivery route may be defined as a route from an origination location to the marine terminal, without including marine shipping rates. System operation is further described in detail below using a marine terminal to destination location example; however, the embodiments described herein are equally applicable for both import and export delivery routes. In export applications of the embodiments, the direction of route travel is reversed, with the origin location serving as the door location in the description below.

Cost estimates may be determined based on a default container size. A container type may include general purpose/dry (GP) containers, high cube (HQ) containers, fuel tanks, temperature-controlled containers, drums, and other standardized shipping containers as well as non-standardized or specialized containers. Container size refers to container length, e.g., 10 GP, 20 GP, and 40 GP.

In some embodiments, the received destination door location may be converted to a door location code. For example, a door location code may be a zip code, regional code (such as 3-digit zip code), or the like.

A door location is a street address, city and state, a municipality, or a region. A door location (also “door point”) may specify the origin of the shipment (for exports) or destination (for imports) for a shipment of cargo. The destination door location is the geographic location at which the carrier will tender the cargo to the recipient. Unique costs are associated with trucking from each door location to each interchange point. Tens of thousands of possible destination door locations may be exist. Due to the large number of possible door locations, exact pricing costs for destination door locations are not individually pre-determined and stored. One exemplary destination door location is illustrated by star 110 of FIG. 1B.

An interchange point is a geographic location serving as a hub for intermodal shipping. Marine pots, rail hubs, and trucking hubs servicing intermodal shipping are examples of interchange points. A marine port, or port of call, is a coastal port where a ship stops to load and/or unload cargo. Any given carrier company maintains significantly fewer interchange points when compared to the number of door locations the carrier services. For example, a carrier company may have less than one hundred marine, rail, and trucking interchange points. Similarly, vessel service is a designated route for ocean vessels. Designated routes may have a pre-determined sequence of ports of call. Accordingly, flat fee costs or cost-per-mile rates may be provided for transit between interchange points in a table format. For example, a rail company may provide specific costs for each transit route between interchange points that the rail company provides. Flat fee costs and cost-per-mile rates may be provided in table form from rail and trucking companies contracting with the carrier. Alternatively or additionally, the carrier may construct and store flat fee costs and cost-per-mile tables in one or more database 26.

Costs are also specific to the type of carrier providing the service. Asset based carriers may have additional route costs that include the use, distribution, and allocation of equipment. In contrast, non-asset based freight brokers contracting with other third party vendors may have equipment costs folded into contractual rates. Some carriers may offer some asset based services while contract with some third party vendors for other services. Accordingly, various embodiments of optimizer 10 provide flexibility based on the carrier specific costs. Accordingly, embodiments of optimizer 10 are applicable to a variety of carriers, whether the freight broker works directly with the shipper or freight broker works only with other carriers, or a combination thereof.

Determination of optimal delivery routes may include the determination of “door” truck rates using and fixed (transportation) costs and variable (non-transportation) costs as well as user-selected parameters to calculate optimized routing.

Door Delivery Costs

Door delivery location may be specified by an address. The street address is converted to a shipping region based on geographic region (such as zip code or 3-digit zip).

Door delivery cost is based on the distance of travel required to truck the cargo from an interchange point to the delivery location. Truck mileage is the total amount of road miles travelled by a truck to drive from the Interchange Point to the delivery door location. Multiple interchange points may service a single door location. For example, delivery interchange points 120A each service door location 110 in FIG. 1B.

In some embodiments, the distance of travel further includes the driving distance required to source or terminate the empty container prior to or following the delivery. The driving distance used to determine door delivery cost may include the driving distance for sourcing an empty container (for exports) or where the empty container is terminated following delivery (for imports). In some embodiments, the empty location point may be the same interchange point as the delivery interchange point.

Door delivery cost is further dependent on base truck cost. Trucking cost-per-mile varies by geographic region. Cost-per-mile may be determined by cross-referencing the geographical region of the interchange point from cost-per-mile data stored in database 26 of optimizer 10. Base truck cost is determined by multiplying the truck mileage from interchange point to delivery door location (which may further include driving distance required to source or terminate the container).

Door delivery cost may be further affected by one or more variance costs. Variance costs include geographic or directional-based variances. 3-digit zip code, 5-digit zip code, import/export direction, and hub/location based variance costs may be stored in database 26. Variance costs may be represented as a percentage of cost-per-mile rate. Variance costs may be represented as a flat rate. Variance costs may be zero. Multiple variance costs may be assessed for a segment of travel. For example, one variance cost may be associated with the 3-digit zip code of the interchange point, and a second variance cost may be associated with the 5-digit zip code. Variance costs based on the direction of travel may be based on the Empty Location distance and different costs may apply based on whether the empty container must be sourced or terminated. Another example cost is fuel surcharge costs. Fuel surcharge is a percentage-based value dependent on the base rate, e.g., the cost paid to a motor-carrier to cover the cost of fuel for the movement of a door shipment. The value is a percentage of the agreed base rate for the movement. Fuel surcharge costs may be determined by geographic region and/or by state as a percentage of base truck cost. Fuel surcharge costs may be determined by the customer (shipper) or vendor (motor carrier). Many shippers have their own fuel surcharge schedule. The fuel surcharge costs may be based on surcharge percentages contracted with each individual third party motor-carriers. Fuel surcharge costs may differ between motor-carriers in the same region of travel.

In some embodiments import/export cost variance may be factored in to cost-per-mile determination. That is, cost-per-mile rates may be provided based on the direction of travel and stored in tables of database 26. All variance costs are aggregated and added to the base truck cost to determine the door delivery cost.

Door delivery cost is further affected by accessorial costs. Multiple interchange points may service a door delivery location. FIG. 1B illustrates three possible interchange points 120A servicing the destination door location 110.

Blocks are described in FIGS. 5-10 with reference to the system and components illustrated in FIGS. 2-4. The processes and blocks of FIGS. 5-10 are described below as performed by optimizer 10. In other embodiments, some or all of the processes may be performed by processor 22 of client 20 and may be performed by sets of instructions that are partially or completely stored on memory 24 of client 20. Additional, different, or fewer blocks may be provided. Blocks may be performed concurrently or in orders other than those presented herein. As an example, some embodiments of process 500 of FIG. 5 may not include block B570. In other embodiments the process of block B560 may not include blocks B546 and/or B568.

FIG. 5 is a flow diagram in accordance with one embodiment of intermodal delivery optimization.

In B510, a destination door location is received by processor 22 of optimizer 10. In other embodiments, origin door location, container size, container type, and other specifications may be provided to further determine the optimal delivery route. The user may further be able to specify one or more ports or interchange points that must be included or excluded in the route. User specification of ports or interchange points may be selected based on category such as most cost-effective, fewest delays, highest traffic volume, or other criteria. Input data, such as the destination door location may be entered via input device 26 and display 28 of a workstation 20 and sent to optimizer 10 via network 30.

Destination interchange points that service (e.g., deliver to) the destination door location are determined in block B520 by optimizer 10. In block B530, optimizer 10 calculates a door delivery cost from each destination interchange point to the destination door location. In block B540, optimizer 10 identifies the possible inland transport paths that connect each available port to the destination interchange points. The number of identified paths may be constrained for the benefit of conserving processing resources. For example, an optimal mileage for driving distance may be calculated between the port and door location. Only those possible routes within a tolerance of the optimal mileage may be considered. Alternatively, all possible routes may be identified and considered.

The determined set of inland transport paths may be constrained by a tolerance. In one embodiment, an estimated road distance connecting the interchange point(s) and the destination door location may be determined. Only those paths within a tolerance of the estimated road distance may be identified for further route optimization. Estimated road distance may be determined based on the shortest road distance connecting the interchange point(s) and the destination door location.

In block B550, an inland transport cost is aggregated by processor 22 of optimizer 10 for each of the plurality of inland transport paths. In block B560, a total delivery cost for a plurality of intermodal delivery routes is determined by processor 22 of optimizer 10. Each intermodal delivery route is possible path from a possible port to the destination door location. The total delivery cost includes the inland transport cost and the door delivery cost.

The total delivery cost is a monetary value that represents the sum of all costs associated with a price quotation. Total delivery costs and other individual costs may be rounded. For example, door delivery cost, inland transport costs, or other fees may be rounded based on a round-up factor applied to each cost. A round-up factor of 25 rounds up each cost to the nearest 25 increments. For example, $275.28 may be rounded to $300. Costs may further be applied as a commercial mark-up value percentage. In some embodiments, the round-up factor and commercial mark-up value may be applied to the base rate. Round-up factors may be applied to the base rate following application of commercial mark-up factor. The commercial mark-up value may be applied to estimated costs provided by licensed or contractual rates provided to the carrier from trucking services, before quoting rates to clients.

In block B570, optimizer 10 adds repositioning costs to the total delivery cost for each intermodal delivery route. The total delivery cost is the aggregated cost of each segment of inland transport and the door delivery costs. Repositioning costs may be specifically applicable to asset-based carriers, in order to specifically account for the repositioning costs of moving empty containers to the nearest interchange point or marine port for a specific transaction. Repositioning cost may be determined as a reverse cost on a region-by-region or hub-by-hub basis, rather than individually determined for a shipment based on door location. Reverse costs may be determined periodically by the carrier as a fixed cost.

In block B580, an optimum intermodal delivery route with the lowest total delivery cost is selected from the potential intermodal delivery routes by processor 22 of optimizer 10. The total delivery costs include costs for all modes of transit. The intermodal delivery routes are compared, ranked, and/or otherwise evaluated to determine an optimal intermodal delivery route by optimizer 10. Optimization can be performed on one or more basis. Lowest cost may be a singular basis on which to determine optimization. Mode of transit, time of transit, and other factors may be used to determine an optimal route. Optimal routes may further be selected to include one or more particular ports/interchange points, avoid a particular mode of transit, use only selected modes of transit and the like.

A set of optimal intermodal delivery routes may be determined. The set may include the optimal delivery route from each port. The set may include the optimal route for each basis. For example, the set may include the lowest cost route, the fastest route, the route with the fewest mode of transit changes, the route with the fewest interchange points, the shortest geographical travel distance and the like. Optimization parameters may further be specified to optimize based on energy efficient or eco-friendly routes. Optimization may further include avoidance of specific regions, states, countries, and the like. Optimization may also include avoidance of specific types of charges such as tolls, accessorials, or to minimize specific costs such as repositioning costs. In some embodiments, the optimization may be used to compare costs based on mode of transit. For example, the set of optimal routes may include lowest cost of truck/rail routing versus all truck routing. Such sets of results may be further evaluated by optimizer 10 to determine cost differentials amongst potential routes.

In block B590, optimizer 10 provides the optimum intermodal delivery route for display at workstation 20 via network 30. The optimum intermodal delivery route may be rendered on display 28 of workstation 20. Mapping and other display components may be stored on one or more databases 26 and provided to workstation 20.

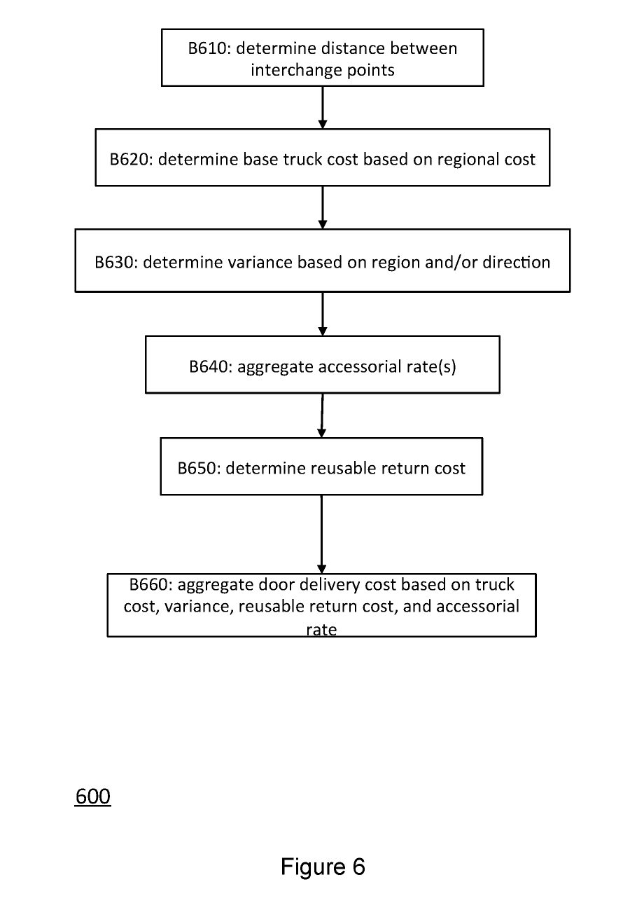

FIG. 6 is a flow diagram illustrating one example process 600 for calculating door delivery cost between each destination intersection point and destination door location. For example, process 600 may be performed by processor 22 of optimizer 10 and may be performed as part of block B530 of FIG. 5.

In block B610, a door location distance between each destination intersection point and destination door location is determined. In block B620, the base truck cost associated with regional cost is determined. Variance based on region and/or direction of travel is determined in block B630. Accessorial rates are aggregated in block B640. Where applicable reusable return cost is determined where applicable in block B650. In block B660, the door delivery cost including truck cost, variance, reusable return cost, accessorial rate and any applicable reusable return cost is aggregated.

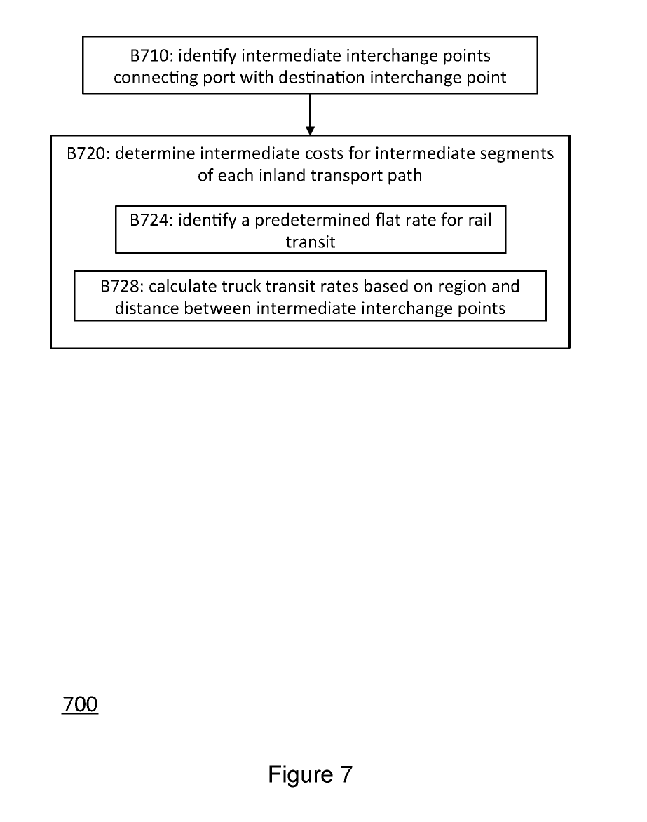

FIG. 7 is a flow diagram illustrating one exemplary process 700 for identifying possible inland transport paths from ports to destination interchange points. For example, process 700 may be performed by processor 22 of optimizer 10 and may be performed as part of block B540 of FIG. 5.

In block B710, one or more intermediate interchange points is identified. Each inland transport path connects each port and each destination interchange point via the one or more intermediate interchange points. In block B720, inland transportation costs are determined for each segment of each inland transport path. Each segment connects one port with one intermediate interchange point, one intermediate interchange point with another intermediate interchange point, or one intermediate interchange point and one destination interchange point. Block B720 may be executed via block B724 and block B728.

In block B724, a predetermined flat rate for segments of inland transport paths indicative of rail transit is identified. Rail transit costs may be fixed for each segment of travel. Such costs may be available based on rail transit from one interchange point to another interchange point.

In block B728, truck transit rates are calculated for segments of inland transport paths. Each truck transit rate is indicative of truck transit based on region and distance associated with the segment of the inland transport path. Truck transit rates for segments of inland transport paths may be conducted in a similar manner to the calculation of the truck transit rate for the door delivery cost. Accordingly, variance and accessorial costs specific to segment distances and geographic locations, may be assessed in the same manner as otherwise described herein.

Accessorial Costs

Segment delivery cost is further affected by accessorial costs. Accessorial costs are add-on costs that are incurred at specific terminals and/or interchange points. An extra fee charged for actions/duties beyond the standard shipping of a shipment from origin to destination. Some examples of these costs include but are not limited to gate fees, terminal-specific bridge fees, chassis split, and chassis dray costs. The majority of hubs (cities) have multiple terminals, and each terminal within a hub may have unique costs associated with it. In Chicago (hub), a shipper is likely to utilize one rail terminal to access the East Coast and another rail terminal to access the West Coast. The rail terminal with West Coast access may be a start/stop location for chassis while the rail terminal with East Coast access may not be a start/stop location for chassis. In the second scenario, the chassis would need to be drayed to a separate “stop” location. This chassis dray cost is one example of a terminal accessorial cost and an example of the necessity to differentiate accessorial costs by terminal and/or direction of movement. For example, flat fee surcharges, tariffs, or other fees may be incurred at various points through the inland transport path. A marine terminal accessorial cost may be incurred that is specific to the marine terminal of the port interchange point. Similarly, rail terminals may have individualized accessorial costs. Chassis split costs are accessorial costs incurred. Other accessorial costs may include region and/or route specific costs such as tolls and regional specific costs based on terrain, congestion, driving direction and other factors.

The end-to-end cost may also include costs specific to the port and destination locations. Empty repositioning costs may be incurred by the carrier based on supply and demand and may be factored into to the total end-to-end cost.

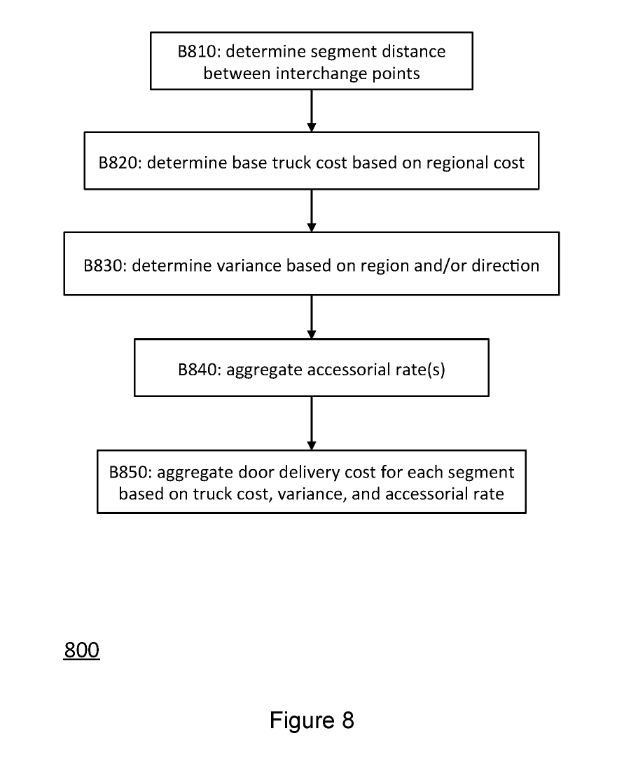

FIG. 8 is a flow diagram illustrating one exemplary process 800 for calculating segment costs between interchange points. Process 800 may be performed by processor 22 of optimizer 10 and may be performed as part of block B728 of FIG. 7.

B810, a segment distance is determined. In block B820, the base truck cost associated with the segment is determined. The variance based on regional cost associated with the segment is determined in block B830. Variance may further be based on direction of travel. The accessorial rate is aggregated in block B840, and the inland transport cost including truck cost, variance, reusable return cost, and accessorial rate is aggregated in block B850.

Distance Range Cost Determination

Based on historical container movement by third party vendors (motor-carriers) over a specified time frame, optimizer 10 may determine a database containing base truck rates categorized by region. Historic cost data may be derived by average market cost within each region. Flat rates may be determined for regions for some distance ranges (e.g., 0-10 miles, 100-200 miles). For other distance ranges, a rate calculation method may be specified instead of a flat rate. For example, if historical costs for a particular distance range vary widely, the calculation method may be average cost per mile rate. Alternatively or additionally, over a predetermined distance threshold, the calculation method may switch from flat rate to a calculation method. Flat rates may be rounded up to nearest ten-dollar increment or other increment. Rounded flat rates are beneficial so that the provided display of segment costs may be easily identified.

These cost determinations may be used to determine the cost of a segment of travel as a flat rate in lieu of other processes as described herein. These cost determinations may be further used for one or more segment cost determinations if specific rate, variance, or accessorial data is unavailable for a segment. In one example, distance range cost based on a 3-digit zip code may be determined for door delivery cost if cost-per-mile rates are outdated or not separately specified for the 5-digit zip code.

Beneficially, distance range cost determination may be used to determine segment and door delivery costs where specific rate information is not available. Distance range cost determination may be used to determine minimum delivery door costs. For door distances geographically close to an interchange point, door pricing is more efficiently and expediently determined, as the processor need not generate individual pricing per-mile when cost differences may be negligible.

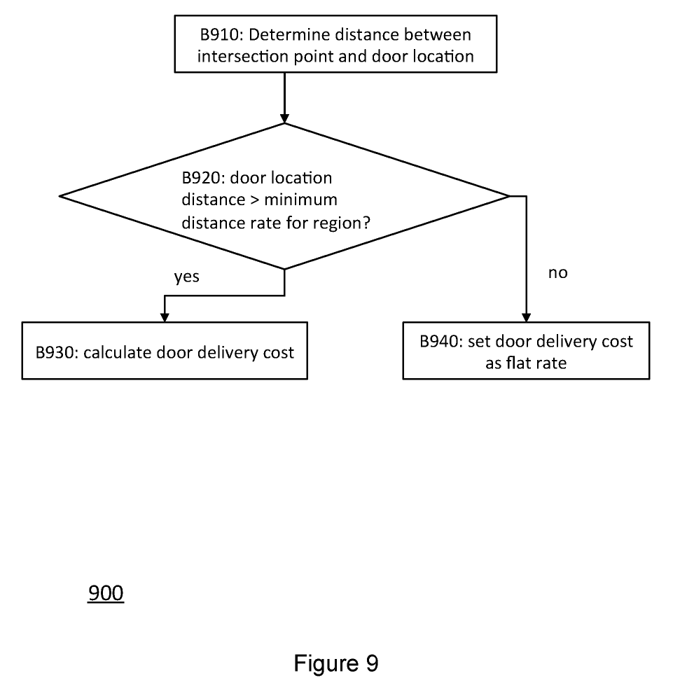

FIG. 9 is a flow diagram illustrating another exemplary process 900 for calculating segment costs that may be performed by processor 22 of optimizer 10 as part of the process of FIG. 5.

In block B910, door location distance is determined between intersection point and destination door location. In block B920, the door location distance is compared to minimum distance rate for region threshold. In block B930, the door delivery cost is calculated. Calculation of the door delivery cost may be determined as otherwise described herein. In B940, the door delivery cost is set as regional flat rate when door location distance is less than or equal to region threshold.

Variance/Variable Costs

Segments may have variable costs specifically associated with movement to or from one interchange point to another, e.g., tolls and fees, and gate fees. Depending on whether a shipment is an import going to/via a specific hub or an export going from/via a specific hub can impact rates quoted by motor carriers. Hub/Location variance is the variance of cost based on the pairing of the door destination (e.g., city, state) and a delivery interchange point. This variance may be limited to regions/hubs dependent on one-way trucking. For example, an import being trucked from Los Angeles, Calif. (hub) to Scottsdale, Ariz. (empty container returned to Phoenix, Ariz.) may cost 30% more than an export being trucked to Los Angeles, Calif. (hub) from Scottsdale, Ariz. (empty container sourced from Phoenix, Ariz.). Variance costs may be determined at varying levels of detail, such as based on 5-digit zip codes or based on the broader 3-digit zip code regions. Variance may be calculated as a fixed-value basis or percentage basis.

Door Destination Within Port Interchange Point

In some embodiments, the door destination interchange point may be in the same geographic region, meaning the inland route is an all-truck route (no possible need for rail). Each port may have several terminals and there are usually different accessorial surcharges associated with each marine terminal. The optimizer 10 identifies destination interchange point and port as same value. Upon identification, the user may be prompted to specify or select the desired marine terminal code (and thus the specific accessorial surcharge associated with that marine terminal). Marine terminal codes may be stored in one or more databases 26 of optimizer 10.

Operational Customization

The user interface displayed on workstation 20. Default selections and preferences may be established to address the needs of an individual shipper's operation/procurement department that is responsible for cost containment and management and other specific uses. Accordingly, the user interface and display may be customized to facilitate internal rates, commercial rate quotation, or other functions. For example, base truck transit rates may be ranked and displayed in a graphical user interface in order to determine or adjust mark-up or other adjusted values.

Input information may be customized as well. For example, origin and destination location, port selection, vessel service selection, container size, container type, travel direction, and other preferences may input by the user to further customize the optimization.

Providing Output and Output Display

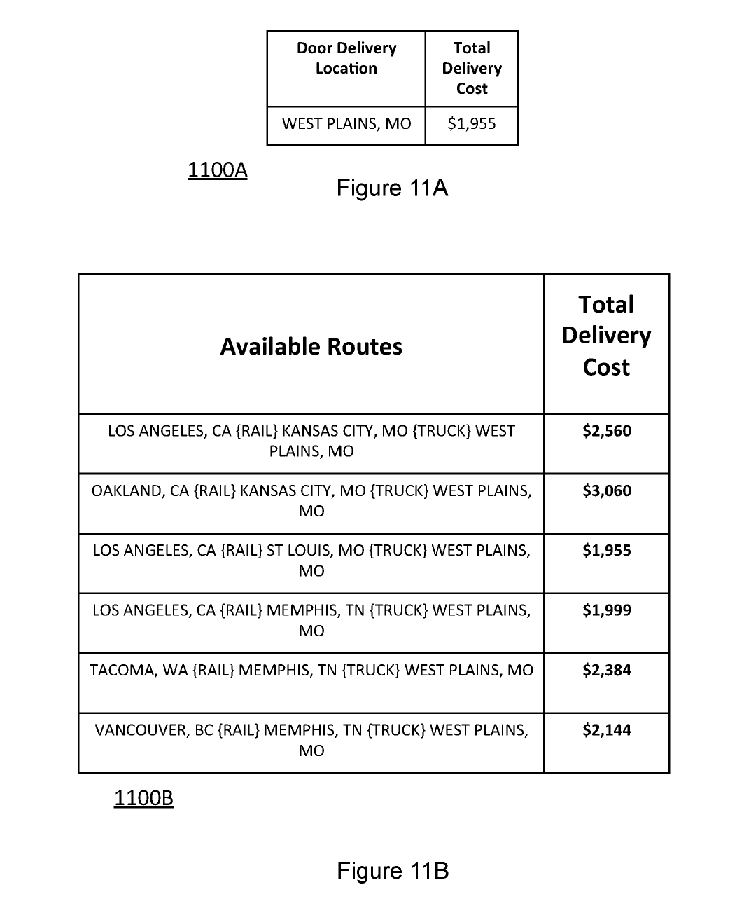

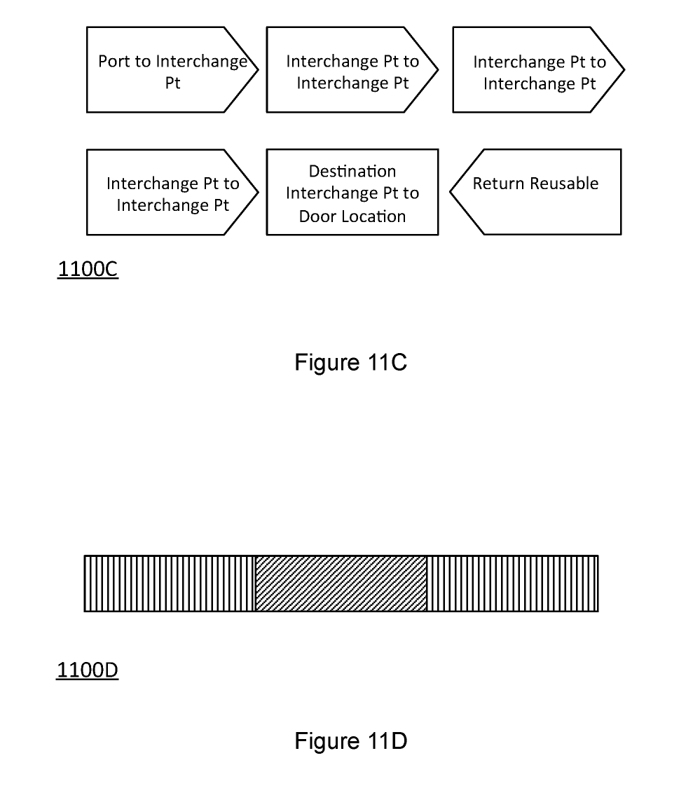

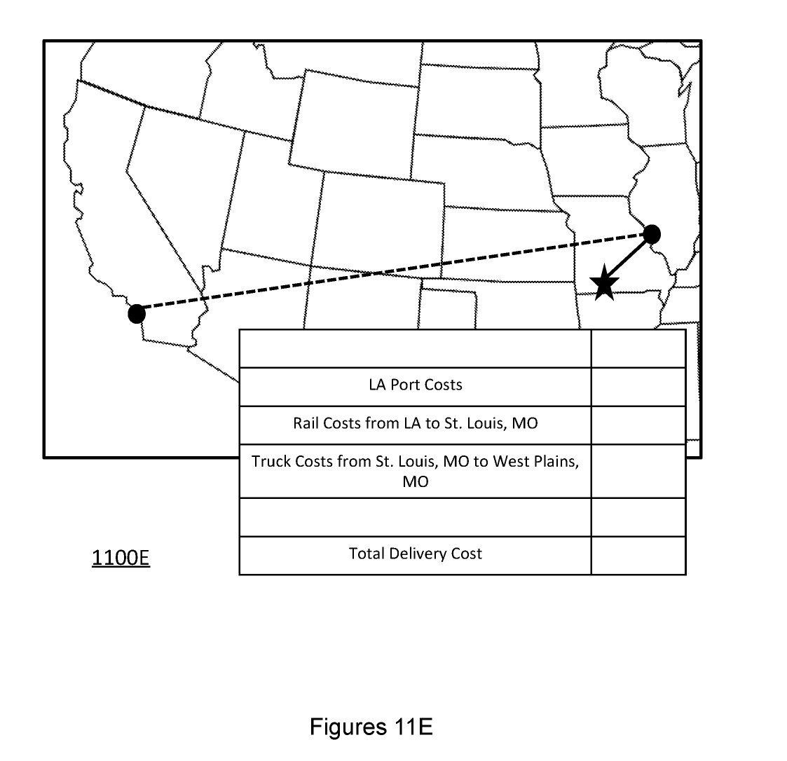

The optimum intermodal delivery route is provided by optimizer 10 to display 28 of workstation 20 via network 30. The provided route and optimization may be presented in a number of forms. FIGS. 11A-11E are example graphical user interfaces providing the optimized intermodal delivery route.

The FIG. 11A provides a table-based display of the total, end-to-end delivery cost for the optimum intermodal delivery route to the specified door delivery location.

FIG. 11B provides an alternative table-based display providing a description of the available routes and total delivery cost. The optimum intermodal delivery route may be highlighted or otherwise visually distinguished from other available routes. The available routes may be shown in a ranked order based on cost.

FIG. 11C illustrates an example display of the optimum intermodal delivery route using a graphical depiction of the route from end-to-end. Individual segments may be identified based on interchange points. The graphical shapes of each segment may indicate direction of travel. Visually distinct shapes may also be used to identify the destination location, mode of transit, or type of transit. For example, the return reusable shape is distinct from other segment graphics so that segment of the optimum route in which the return of the empty container is easily identifiable.

The intermodal delivery route may be indicated by a segmented bar, as shown in FIG. 11D. The path of the route is illustrated with concatenated segments of the bar corresponding to the delivery path. Each leg of the trip is represented by a segment of the bar. Patterns and colors may be employed to identify the mode of transit, the cost, or other identifying factor. The length of the segment may be proportional to the distance or time to provide a pictorial reference.

The optimum intermodal delivery route may further be provided for display as a route map as illustrated in FIG. 11E. Segment cost, mode of transit, distance, intersection point and other information may be graphically depicted on the map. Alternatively or additionally, data may be provided for display simultaneously in table form. Only the optimum delivery route may be shown, or multiple possible delivery routes may be shown and differentiated graphically.

Graphical display elements illustrated in FIGS. 11A-11E may be combined. The user may further specify a set of filters customizing the default view for results. Multiple displays may be navigated through and accessed via input devices 26 and Display 28 of workstation 20. Graphical map displays may include components illustrated in the map displays 100A, 100B, 100C, and 100D of FIGS. 1A-1D, respectively.

Completing the Transaction

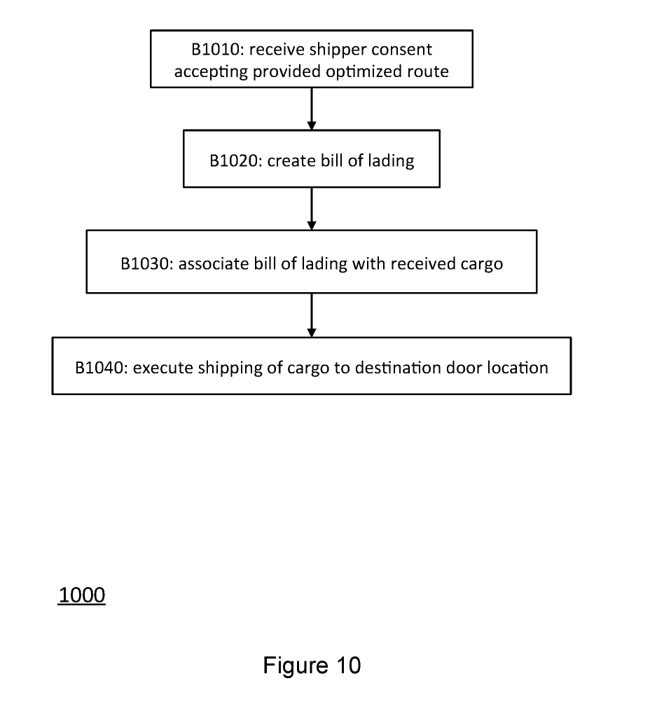

FIG. 10 illustrates an exemplary process for completing a shipping transaction for intermodal delivery optimization.

In block B1010, an indication of consent accepting optimum intermodal delivery route is received. In B1020, a bill of lading based on the optimum intermodal delivery route is created. The bill of lading (e.g., shipping contract) may be created based on the received destination location and the optimized route. The bill of lading may include specifications associated with the port-to-port shipment of the cargo from the port of loading to the port of discharge. For example, the bill of lading may specify the carrier's responsibility for the cargo from an identified port of loading to the port of discharge.

In block B1030, the bill of lading is associated with the received cargo. In block B1040, shipping of cargo to the destination door location.

Illustrations are merely representational and are not drawn to scale. Accordingly, the disclosure and accompanying figures are illustrative rather than restrictive. Specifics provided herein are not intended to be construed as limitations on the scope of the invention or of what may be claimed but are instead descriptions of features specific to particular embodiments of the invention. Features described in the context of separate embodiments may be implemented in combination in a single embodiment.

Operations, processes, blocks, and acts are illustrated in the drawings and described in a particular order. However, no particular order should be construed as a requirement that operations must be performed exclusively within the sequential order. Additional or fewer operations may be performed or operations may be advantageously performed using parallel processing.

It is intended that the foregoing detailed description be regarded as illustrative rather than limiting and that it is understood that the following claims including all equivalents are intended to define the scope of the invention.

I claim:

1. An intermodal delivery optimization system comprising:
at least one processor; and
at least one memory including computer program code for one or more programs; the at least one memory and the computer program code configured to, with the at least one processor, cause the system to at least perform:
receive a destination door location;
determine a plurality of destination interchange points delivering to the destination door location;
calculate a door delivery cost from each destination interchange point to the destination door location;
identify a plurality of inland transport paths from one or more possible ports to each of the plurality of destination interchange points;
aggregate an inland transport cost for each of the plurality of inland transport paths;
determine a total delivery cost for a plurality of intermodal delivery routes, wherein each intermodal delivery route is a path from a possible port to the destination door location, and wherein the total delivery cost includes the inland transport cost and the door delivery cost;
select an optimum intermodal delivery route from the plurality of intermodal delivery routes with the lowest total delivery cost; and
provide the optimum intermodal delivery route for display.

2. The system of claim 1, wherein calculation of the door delivery cost from each destination interchange point to the destination door location, further causes the system to perform:
determine a door location distance between each destination intersection point and destination door location;
determine base truck cost associated with regional cost;
determine variance based on region;
aggregate accessorial rate; and
aggregate door delivery cost including truck cost, variance, reusable return cost, and accessorial rate.

3. The system of claim 2, wherein calculation of the door delivery cost from each destination interchange point to the destination door location, further causes the system to perform:
determine reusable return cost; and wherein the door delivery cost is further aggregated to include the reusable return cost.

4. The system of claim 2, wherein variance is further based on direction of travel.

5. The system of claim 1, wherein identification of the plurality of inland transport paths from one or more possible ports to each of the plurality of destination interchange points, further causes the system to perform:
identify one or more intermediate interchange points, wherein each inland transport path connects each port and each destination interchange point via the one or more intermediate interchange points; and
determine inland transportation costs for each segment of each inland transport path, wherein each segment connects one port with one intermediate interchange point, one intermediate interchange point with another intermediate interchange point, or one intermediate interchange point and one destination interchange point.

6. The system of claim 5, wherein identification of the plurality of inland transport paths from one or more possible ports to each of the plurality of destination interchange points, further causes the system to perform:
identify a predetermined flat rate for segments of inland transport paths indicative of rail transit; and
calculate truck transit rates for segments of inland transport paths indicative of truck transit based on region and distance associated with the segment of the inland transport path.

7. The system of claim 5, wherein calculation of truck transit rates based on region and distance associated with the segment of the inland transport path, further causes the system to perform:
determine a segment distance of the segment;
determine base truck cost associated with the segment;
determine variance based on regional cost associated with the segment;
aggregate accessorial rate; and
aggregate inland transport cost including truck cost, variance, reusable return cost, and accessorial rate.

8. The system of claim 5, wherein variance is further based on direction of travel.

9. The system of claim 1, wherein calculation of the door delivery cost from each destination interchange point to the destination door location, further causes the system to perform:
determine a door location distance between intersection point and destination door location;
compare the door location distance to minimum distance rate for region threshold; and
set the door delivery cost as regional flat rate when door location distance is less than or equal to region threshold.

10. The system of claim 1, the at least one memory and the computer program code configured to, with the at least one processor, further cause the system to perform:
add repositioning costs to the total delivery cost for each intermodal delivery route.

11. The system of claim 1, the at least one memory and the computer program code configured to, with the at least one processor, further cause the system to perform:
receive indication of consent accepting optimum intermodal delivery route;
create a bill of lading based on the optimum intermodal delivery route;
associate bill of lading with received cargo; and
execute shipping of cargo to the destination door location.

12. A method for intermodal delivery optimization is provided, the method comprising:
receiving a destination door location;
determining a plurality of destination interchange points delivering to the destination door location;
calculating a door delivery cost from each destination interchange point to the destination door location;
identifying a plurality of inland transport paths from one or more possible ports to each of the plurality of destination interchange points;
aggregating an inland transport cost for each of the plurality of inland transport paths;
determining a total delivery cost for a plurality of intermodal delivery routes, wherein each intermodal delivery route is a path from a possible port to the destination door location, and wherein the total delivery cost includes the inland transport cost and the door delivery cost;
selecting an optimum intermodal delivery route from the plurality of intermodal delivery routes with the lowest total delivery cost; and
providing the optimum intermodal delivery route for display.

13. The method of claim 12, wherein calculating the door delivery cost from each destination interchange point to the destination door location, further comprises:
determining a door location distance between each destination intersection point and destination door location;
determining base truck cost associated with regional cost;
determining variance based on region;
aggregating accessorial rate; and
aggregating door delivery cost including truck cost, variance, reusable return cost, and accessorial rate.

14. The method of claim 13, wherein calculating the door delivery cost from each destination interchange point to the destination door location includes:
determining reusable return cost; and wherein aggregating the door delivery cost is further includes the reusable return cost.

15. The method of claim 13, wherein variance is further based on direction of travel.

16. The method of claim 12, wherein identification of the plurality of inland transport paths from one or more possible ports to each of the plurality of destination interchange points, further comprises:
identifying one or more intermediate interchange points, wherein each inland transport path connects each port and each destination interchange point via the one or more intermediate interchange points; and
determining inland transportation costs for each segment of each inland transport path, wherein each segment connects one port with one intermediate interchange point, one intermediate interchange point with another intermediate interchange point, or one intermediate interchange point and one destination interchange point.

17. The method of claim 16, wherein identification of the plurality of inland transport paths from one or more possible ports to each of the plurality of destination interchange points, further causes the system to perform:
identifying a predetermined flat rate for segments of inland transport paths indicative of rail transit; and
calculating truck transit rates for segments of inland transport paths indicative of truck transit based on region and distance associated with the segment of the inland transport path.

18. The method of claim 16, wherein calculating of truck transit rates based on region and distance associated with the segment of the inland transport path, further comprises:
determining a segment distance of the segment;
determining base truck cost associated with the segment;
determining variance based on regional cost associated with the segment;
aggregating accessorial rate; and
aggregating inland transport cost including truck cost, variance, reusable return cost, and accessorial rate.

19. The method of claim 12, wherein calculating the door delivery cost from each destination interchange point to the destination door location, further includes:
determining a door location distance between intersection point and destination door location;
comparing the door location distance to minimum distance rate for region threshold; and
setting the door delivery cost as regional flat rate when door location distance is less than or equal to region threshold.

20. A non-transitory computer readable medium including instructions that, when executed, are operable to:
receive a destination door location;
determine a plurality of destination interchange points delivering to the destination door location;
calculate a door delivery cost from each destination interchange point to the destination door location;
identify a plurality of inland transport paths from one or more possible ports to each of the plurality of destination interchange points;
aggregate an inland transport cost for each of the plurality of inland transport paths;
determine a total delivery cost for a plurality of intermodal delivery routes, wherein each intermodal delivery route is a path from a possible port to the destination door location, and wherein the total delivery cost includes the inland transport cost and the door delivery cost;
select an optimum intermodal delivery route from the plurality of intermodal delivery routes with the lowest total delivery cost; and
provide the optimum intermodal delivery route for display.
